(19) United States
(12) Patent Application Publication
(10) Pub. No.: US 2007/0233507 A1
(43) Pub. Date: Oct. 4, 2007

(54) DISTRIBUTION SYSTEM

(76) Inventor: Mark W. Publicover, Saratoga, CA (US)

Correspondence Address: KLARQUIST SPARKMAN, LLP, 121 SW SALMON STREET, SUITE 1600, PORTLAND, OR, 97204, US

(21) Appl. No.: 11/548,690

(22) Filed: Oct. 11, 2006

Related U.S. Application Data
(63) Continuation of application No. 10/632,124, filed on Jul. 30, 2003, now abandoned.
Application No. 10/632,124 is a continuation of application No. 09/480,051, filed on Jan. 10, 2000, now abandoned.
(60) Provisional application No. 60/115,444, filed on Jan. 8, 1999.

(51) Int. Cl. G06Q 99/00

(52) U.S. Cl. 705/1

(57) ABSTRACT

Disclosed are systems (including members-only systems) and methods for distribution of items to individuals. Such systems and methods are highly efficient, environmentally conscious and permit a greater amount of control on the part of the customer in how, when and where distribution occurs.

This is a continuation of U.S. application Ser. No. 10/632,124, filed Jul. 30, 2003, which is a continuation of U.S. application Ser. No. 09/480,051, filed Jan. 10, 2000, now abandoned, which claims the benefit of U.S. Provisional Application No. 60/115,444, filed Jan. 8, 1999, all of which applications are incorporated herein by reference.

### BACKGROUND

The present invention relates to systems and methods for distribution of items to individuals and businesses.

In the modern world, there is a growing unsatisfied need for convenient, individualized, rapid and environmentally conscious delivery of items. Current systems for distribution are time, labor and resource intensive and wasteful in that delivery is to each ordering individual's home or place of business. In addition to these inherent inefficiencies, delivery to a private residence or small business can cause certain other inconveniences for the ordering individual, including requiring that someone be at the delivery address to accept the delivery or risk loss of the item if it is left on the doorstep. Entry of a delivery person to private property is not always advisable, as it can result in property damage including broken gates, trampled gardens, and the like.

Existing distributions systems also are prone to accidental product loss as well as theft and misappropriation. Various private mailing systems use a form of computerized monitoring that permits the company to keep track of the location of packages at certain points during shipment. These systems, however, still rely on delivery of individual packages directly to residences or places of business of individuals. In some cases, multiple deliveries are made to a single, remote address on any given day. These systems are inherently inefficient and contribute to greenhouse gas pollution.

It is to methods and systems of item distribution that overcome such problems that this invention is directed.

### SUMMARY

This invention incorporates existing and new technology to create a system for distribution of goods to individuals, for instance individual consumers. Systems according to the present invention incorporate one or more of the aspects described below and provide a more efficient way to distribute goods to consumers relative to known methods, thereby reducing costs, time, waste, and environmental pollution while providing the consumer with greater convenience and better service.

One aspect of this invention is method of distributing one or more items to individuals. The method includes receiving an order from the individual, generating an order packet corresponding to the order, shipping the at least one item to a consolidating distribution center (CDC), where the item(s) are packaged and labeled so as to be identifiable as intended for the individual to create a shipment. This shipment is then transported to a substantially unattended secure designated item exchange site (DS) from which the individual or a designated agent retrieves it. The distribution system is set up such that other individuals can use the same DS to receive their own shipments.

In certain embodiments of the invention, the distribution system is a members-only distribution system, in that the individuals must be registered with the system in order to participate.

The substantially unattended secure designated item exchange site (DS) is a key element of the system and methods of the invention. Such a site is “substantially unattended” in that it functions without a human attendant to assist in the regular retrieval of packages. In certain embodiments, the DS is at least semi-automated, in that there is generally no human attendant at the DS. Certain DSs are fully automated, in that the involvement of humans in their functioning is minimal, and may only include the delivery of shipments and retrieval of used packaging materials.

In certain embodiments, the DS is accessed by an individual in order to retrieve the shipment through use of a personal identifier, which can be encoded in the form of a physical key (e.g., a key card or biological sample). This personal identifier can identify the individual at least in part through information chosen from the group consisting of biometric, numeric, alpha-numeric, alphabetic, physical, statistically assigned and randomly assigned. Biometric information can include a retinal scan, a digital thumbprint, a voiceprint, a chemical skin print, a pheromone print, a genetic print, an odor print and combinations thereof.

Identification at the DS, rather than using a key card, can also employ a “biological sample” or biological reading, for instance as small sample of sweat, blood, spittle, breath, hair, dermal cells, dermal cell contact and mixtures thereof. These samples are usually taken in a substantially non-damaging and substantially non-irritating way so as to provide little inconvenience to the individual retrieving the order.

The distribution system of this invention is largely automated, including automatic notification of transit of shipment packages through the system. Thus, certain embodiments of this invention will include automatic notification of interested parties (for instance, the orderer or the system) when the shipment arrives at the DS or is retrieved from the DS. Other parties that may be notified include item suppliers, distribution centers, consolidated distribution centers and the appropriate member/individual. The system is organized by and around a computer system that monitors and can mediate such notification.

Packages and, in some instances, items that travel through the distribution system of this invention are labeled in such a way as to be identifiable at least by who the corresponding intended recipient is. Such labeling can be accomplished by, for instance, a smart chip attached to the item or package. The contents of this smart chip can include information relating to the individual, the individual personal identifier, the order, the item(s) ordered, the secure designated site, the consolidated distribution center, the shipment or the order packet.

In certain aspects of the invention, items of the order are supplied by two or more suppliers.

Distribution systems and methods of the invention help to minimize or eliminate tampering with products, reduce product waste by spoilage or breakage by excessive handling throughout the distribution chain (e.g., no shelf stockers in the stores to drop a good while putting up a retail display, etc.), dramatically reduce overall cost of distribution by taking several links out of the current distribution chain, reduce transport-related (exhaust) greenhouse gases by making DSs most convenient for the consumer, increase quality of life by significantly shortening the length of time needed to shop and/or return unwanted goods, and reduce middle-man costs.

Those skilled in the art will appreciate the utility of this invention is not limited to the specific modes, components and materials described herein. The foregoing and other features and advantages of the invention will become more apparent from the following detailed description and accompanying drawings.

### BRIEF DESCRIPTION OF THE DRAWINGS

FIG. 1 is a block diagram of one embodiment of the disclosed method and system for distribution of items, showing a single manufacturer and a single substantially unattended secure designated item exchange site.

FIG. 2 is a block diagram of one embodiment of the disclosed method and system for distribution of items, showing multiple manufacturers and designated sites.

FIG. 3 is a block diagram of one component, the consolidating distribution center, of a distribution system according to one embodiment of this invention.

FIG. 4 is a flowchart depicting an overall view of the operation of an embodiment of the distribution system of the invention.

FIG. 5 is a block diagram of one component, a generic substantially unattended secure designated item exchange site, of an embodiment of a distribution system of the invention.

FIGS. 6A through 6D are a series of block diagrams of various embodiments of one component, the substantially unattended secure designated item exchange site, of a distribution system according to this invention. FIG. 6A shows a multiple-shipment room designated site; FIG. 6B shows an individual-shipment, bi-access designated site; FIG. 6C shows an individual-shipment, single-access designated site; and FIG. 6D shows an individual vehicle direct delivery designated site, each of which can serve as substantially unattended secure designated item exchange sites.

FIG. 7 is a flowchart depicting the lock/un-lock and un-labeled/labeled status of a consolidated shipment during its movement through a distribution system of the present invention.

FIG. 8 is a flowchart depicting the overall activities of the method of use of the distribution system according to the invention.

### DETAILED DESCRIPTION

### I. System for Distribution of at Least One Item to an Individual

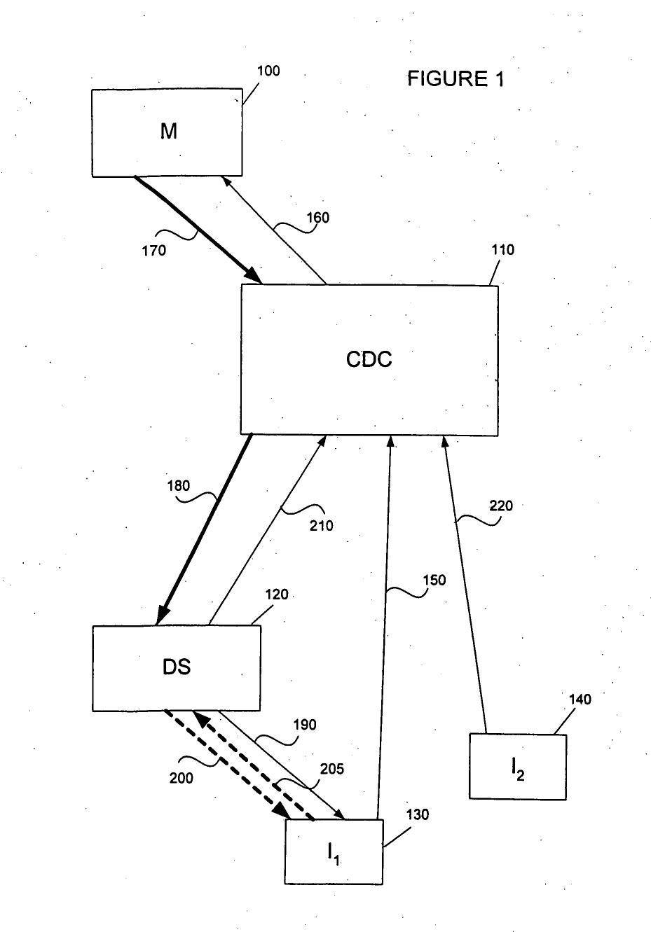

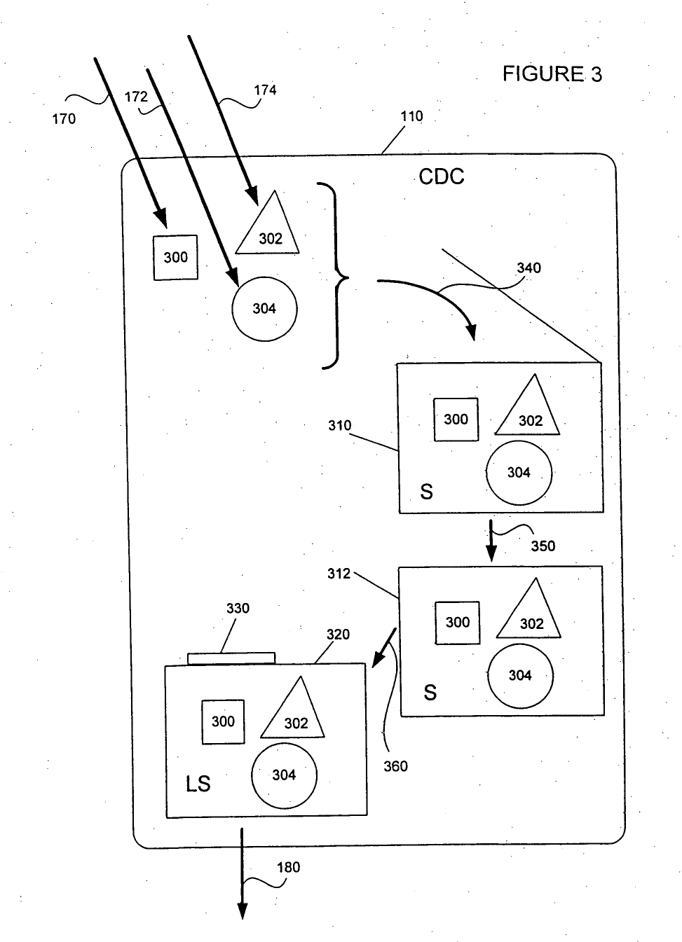

A comprehensive distribution system and methods for its use, according to the present invention, provide efficient, customizable distribution of goods with a minimum of pollution and a maximum of recycling and re-use. In brief overview (FIG. 1), an individual (I₁) 130 places an order 150 with the distribution system, using any communication means (for instance, telephone, e-mail or regular mail). In certain embodiments this order is placed with a centralized system computer, which may or may not be located at a consolidated distribution center (CDC) 110 of the system. As appropriate, information from this order is transmitted 160 (also through any art-known means, such as electronically) to a manufacturer 100 who then provides the item(s) required. For the purpose of this disclosure, the term “manufacturer” refers to a product source, which can be a manufacturing site, an import or domestic distribution warehouse, or the like. The ordered items (e.g., goods; FIG. 3 300, 302 and 304) may be tagged at the factory with a smart chip; this permits the packing system to scan or “read” smart chips affixed to or embedded into the item packaging material, thereby assisting in the routing of those goods to the appropriate CDC.

Ordered and possibly chip-labeled items are shipped 170 to a CDC 110 of the system, usually the CDC that is closest to the individual 130 who placed the order. Within the CDC (FIG. 3), the items (e.g., 300, 302 and 304) of shipment are consolidated 340 into shipping packaging to form an unlocked shipment 310, which is closed and sealed or locked 350 to form a sealed or locked shipment 312. Tags, and especially those which include a smart chip, on the individual items (as discussed above) are particularly helpful in automatic or manual packaging procedures at the CDC, especially where such items have been stored at the CDC for a period prior to completion of the consolidated shipment (e.g., due to a delay until the order can be filled.

Once the shipment is consolidated, it is can be labeled 360 with a shipment smart label 330, and shipped out 180 (e.g., by truck, train or boat) to the appropriate substantially unattended secure designated item exchange site (DS) 120.

Smart chips as used in the disclosed distribution system are generally reprogrammable and reusable for future shipments. Thus, recycling and re-use of these chips, and often the labeling means accompanying and/or incorporating the chip is recommended. However, in some embodiments the smart chip and associated labeling device are designed to be disposable and are, for instance, inactivated upon retrieval of the associated shipment.

The substantially unattended secure designated item exchange site (DS) is a key element of the system and methods of the invention. Such a site is “substantially unattended” in that it functions without a human attendant to assist in the regular (day-to-day) retrieval of packages. In certain embodiments, the DS is at least semi-automated, in that there is generally no human attendant at the DS. Certain DSs are fully automated, in that the involvement of humans in their functioning is minimal, and may only include the delivery of shipments and retrieval of used packaging materials.

Usually the member/individual who placed the order will specify the appropriate DS, which may for instance be the DS closest to the member's home or place of work. When the shipment is delivered to or nearing the DS, the member is notified 190, for instance by e-mail or pager message. The member then travels 205 to the DS 120 and there picks up and retrieves 200 the appropriate shipment. The act of picking up the shipment provides notification 210 to the system, for instance by electronic system to the CDC or another aspect of the system, that the shipment has been successfully delivered.

If the member customer does not pick up a shipment within a specified time, shipment packages could be taken to permanent on-site storage, which may be either at the DS or at another system-associated location. These held shipments would be available for pick-up by the customer using, for instance, the same access and verification methods. In certain embodiments, there may be additional charges assessed for late pick-up.

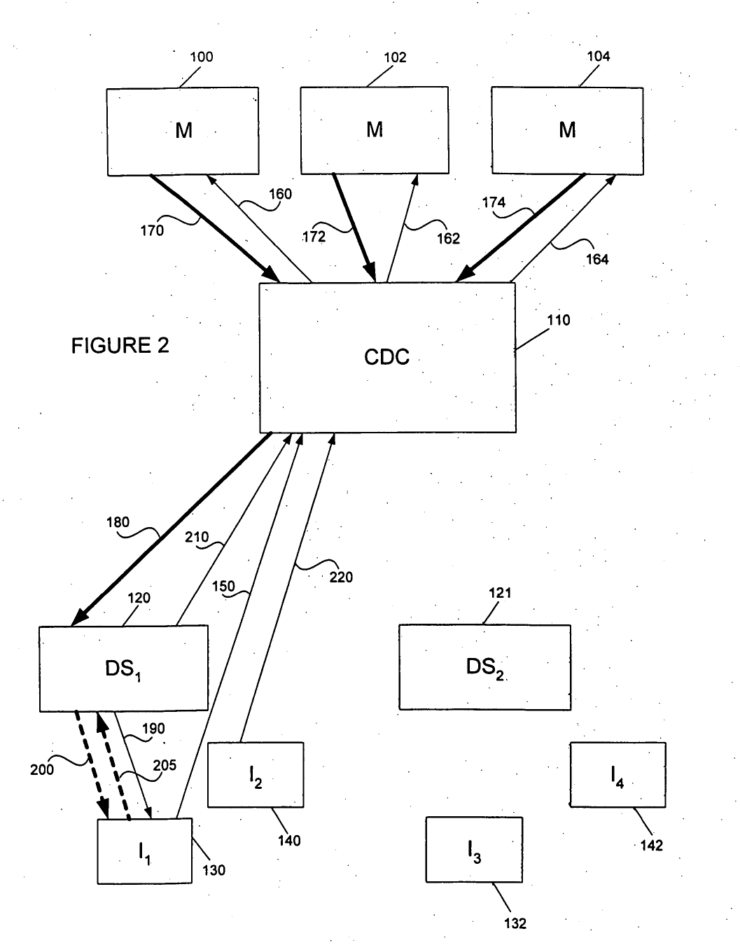

In certain embodiments of the distribution system and method (FIG. 2), multiple manufacturers (100, 102 and 104 for instance) supply items that were ordered by the member individual. Thus, the system will send an order-related communication (160, 162 or 164) to each manufacturer, which will then send (170, 172, 174 respectively) the appropriate items back to the CDC 110 for consolidation.

In addition, the system can include multiple CDCs and multiple DSs (for instance, DS₁ 120 and DS₂ 121). Certain individual members may use specific DSs, depending on their needs, but an individual need not be required to use only a single DS. The DS can be specified with each order placed, and it may occasionally be appropriate for the DS to be changed (for instance, by the individual) after the order is placed with the system.

### II. Movement within the Distribution System

The distribution method of this invention requirements the movement of information and items between various components of the distribution system.

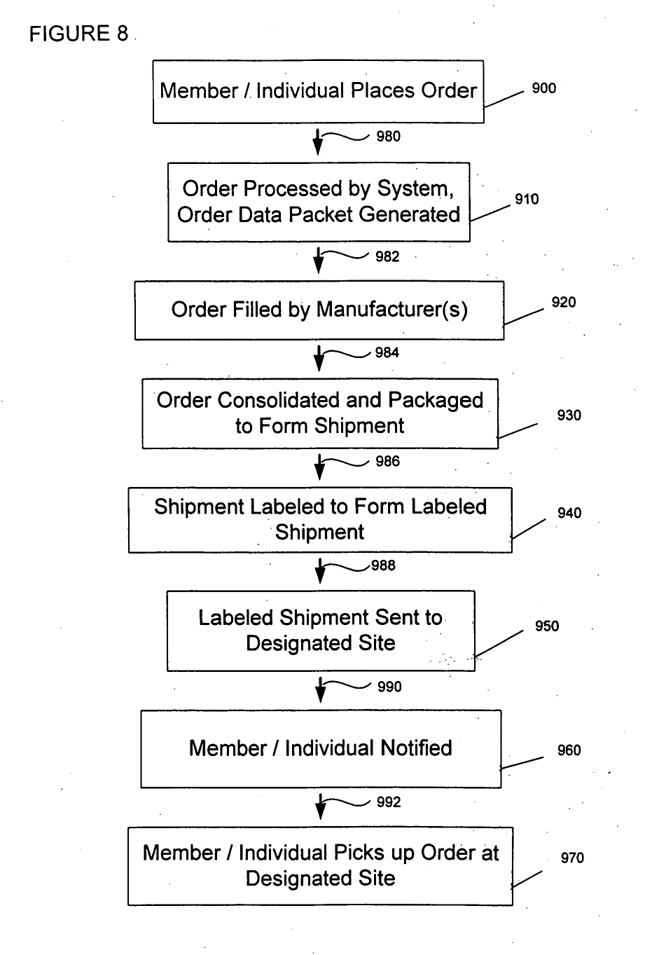

One way of looking at movement within the distribution system is by way of a flowchart, as depicted in FIG. 8. A member/individual places an order 900, which is transmitted 980 to the order processing system (likely a computerized system). The order is processed and an order data packet is generated 910. As required, at least a portion of this order data packet is transmitted 982 to the manufacturer(s), who fill 920 the order and send it 984 to the CDC. At the CDC, the items of the order are consolidated and packaged 930 to form the shipment, which may be transported 986 to a different area of the CDC for labeling 940. Labeling includes attachment of the smart chip (or other data carrier) that is encoded with portions of the order data packet and permits secure and reliable tracking of the shipment. The labeled shipment is then loaded 988 onto a transport means, such as a truck, and delivered 950 to the DS. The member who ordered the shipment is notified 960 of the arrival or imminent arrival of their shipment, and the individual then travels 992 to the DS to pick up 970 their shipment.

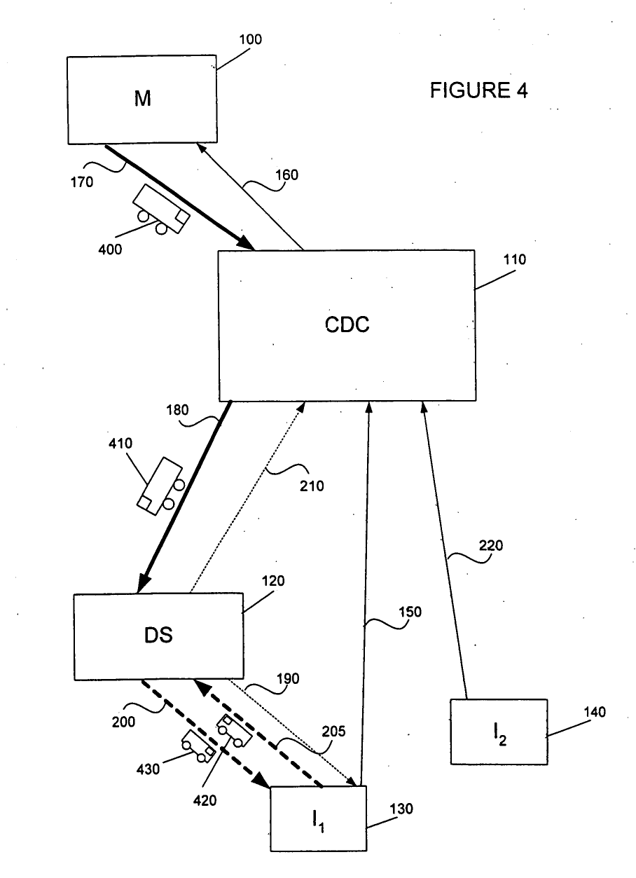

This system involves various instances of data transmission, both active and passive, as well as the physical shipment of items and shipment packages. FIG. 4 more clearly illustrates when each type of communication is occurring. In the pictured embodiment, which serves as a non-limiting example only, communications 150, 160, 190, 210, and 220 are data transmissions, which may occur through any art-known means. Such means include telephone transmissions, electronic encoded transmissions, wireless communications, etc. Certain of these communications may be active, in that a person initiates the communication (e.g., 150 or 220, the placement of orders by individuals). Some communications may be either active (initiated by a person) or automatic/reactive to an event such as a delivery or imminent delivery. Communication 160 is representative of such an active or reactive transmission; in certain embodiments, the manufacturer(s) will receive notice automatically from the distribution system, indicating that an order has been placed. In other embodiments, this transmission will occur with the assistance of a staff member of the distribution system, and as such may be thought of as active. Certain other communications of the system, such as 190 and 210, will likely be truly automatic (purely reactive) in that they are sent on the occurrence of an event and do not generally require the active participation of an individual or staff member.

Communications 170, 180 and 200 of FIG. 4 depict the transport of goods between different components of the distribution system. Items are delivered 170 from the manufacturer to the CDC 110, or delivered 180 from the CDC 110 to the DS 120 by conventional transport methods; vehicles (400 and 410) used in such transport may included trucks, trains, air planes, ships, etc. Retrieval 205, 200 of the shipment from the DS 120 to the individual (for instance, the residence of the individual) will usually use a transport means that is operated by the individual. For instance, the individual may drive a personal vehicle 420 to the DS to pick up a shipment, and then may drive the now-loaded vehicle 430 away from the DS with the shipment.

### III. Designated Sites

The purpose of DSs within the distribution systems is to provide a centralized or semi-centralized site for package delivery from one or more CDC, from which individual members who have placed orders can retrieve their order shipment at their convenience.

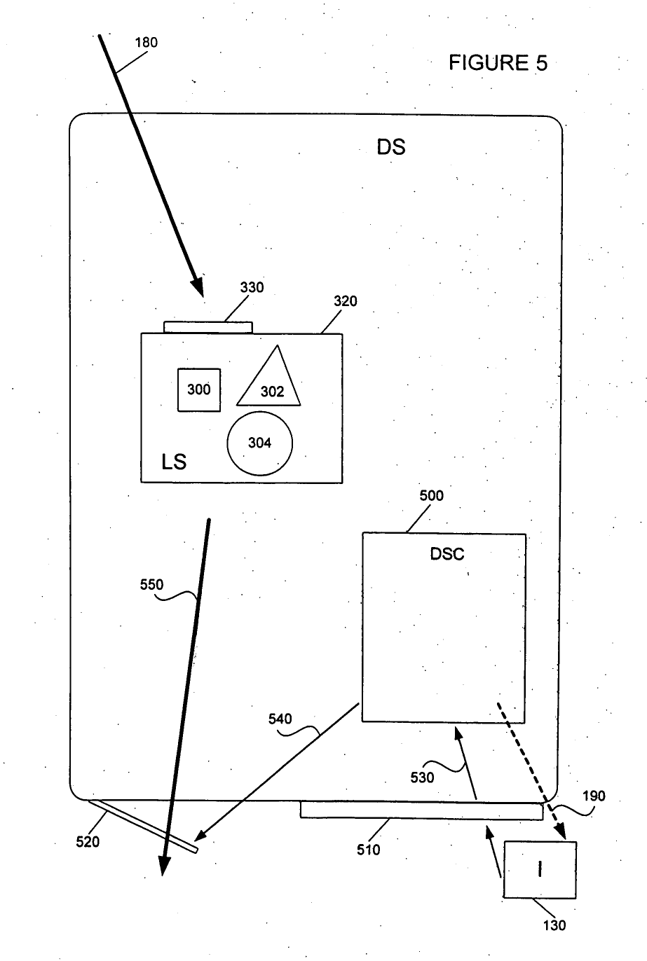

A schematic representation of a generic DS 120 is depicted in FIG. 5. A labeled shipment 320 is received 180 from the CDC. This labeled shipment includes the item(s) ordered (e.g., 300, 302 and 304), and has associated with it a labeling device 330 that incorporates a smart chip. In certain embodiments of the invention, delivery of the labeled shipment 320 to the DS 120 causes the DS-associated computer (DSC) 500 to send a signal 190 to the member/individual 130 who placed the order, informing them that the shipment is available at the DS 120.

After notification, the individual 130 proceeds to the DS 120 and interacts with a DS interface 510. This interaction includes presenting the individual's identification to the DS interface to verify that the individual has an order shipment to pick up and is authorized to enter. Verification through the interface (which may, for instance, be mediated 530 by the DSC) enables a signal 540 to release the door 520 of the DS, thus permitting entry of the individual to retrieve 550 the shipment. Depending on the particular DS format of the system, “entry” may involve the physical entry of all or part (e.g., the member's hands) of the individual member into the interior space of the DS to retrieve the package(s). However, in some embodiments, the package may be mechanically disgorged from the DS, such that the member need not enter the interior space of the DS. “Interior space” as used herein does not require that the space be physically or entirely physically enclosed.

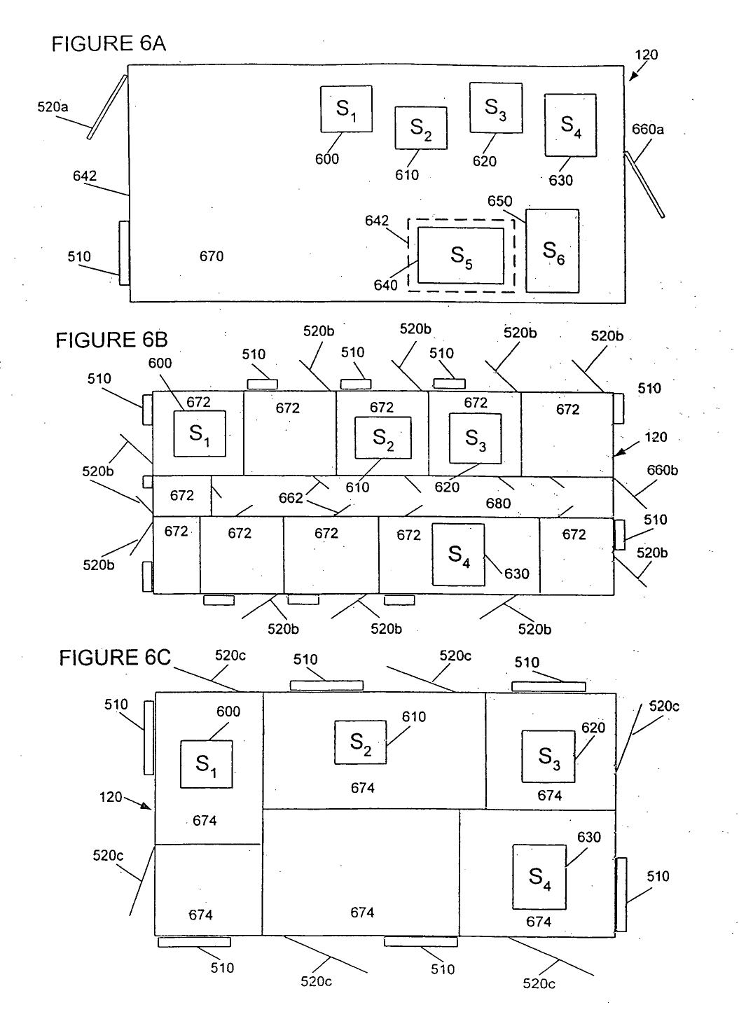

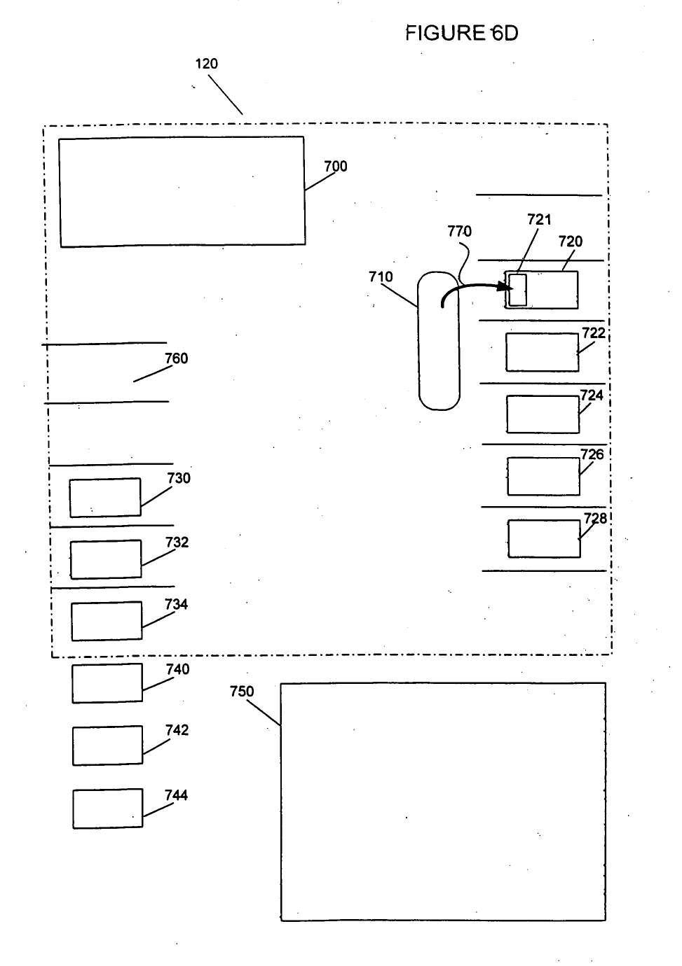

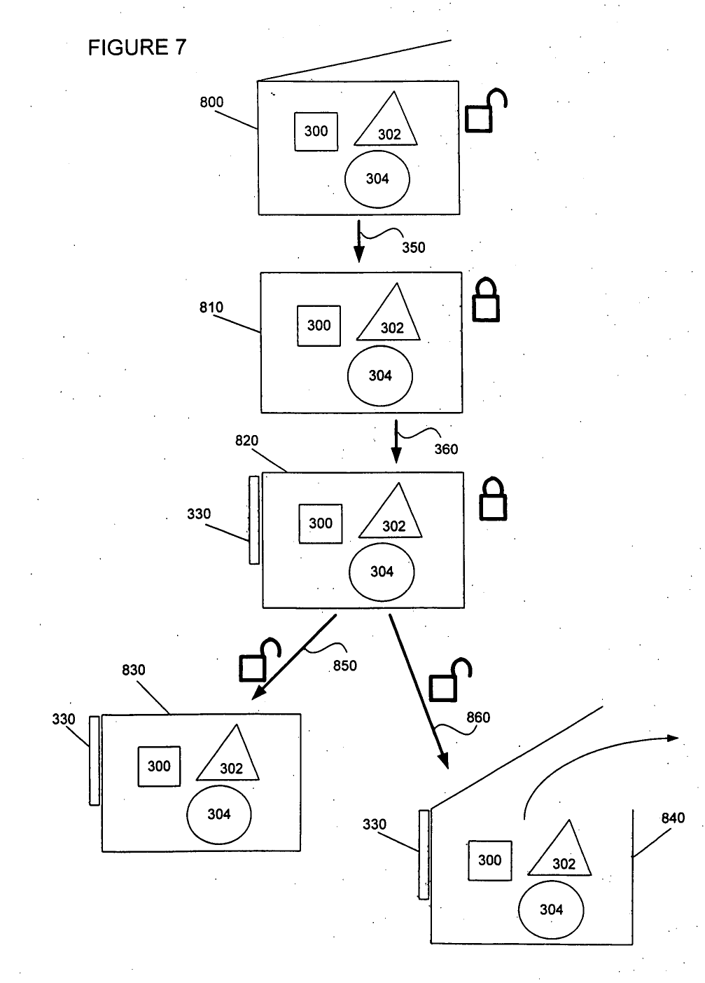

The DS of FIG. 5 is generic. DSs of different embodiments of the invention will be different in their specific execution. Certain of these embodiments are depicted in FIGS. 6A through 6D, though this is not intended to be an exhaustive list of appropriate DS formats. These formats will now be more fully discussed.

A. Centralized DSs

DSs could be located at many types of sites, including, for example, an office of a corporation having a large number of employees; a neighborhood as discussed in Example 2; a central parking facility in a metropolitan area; a mass transit terminal where commuters enter or exit a mass transit system; a school; and a shopping center. Customers could also designate a nearby airport terminal as a DS. Trailers as illustrated in FIGS. 6A-6C could be set up as self-serve (substantially unattended) pick up containers. Certain of such trailers are advantageously equipped with shelving, cubicles, etc., useful for keeping individual orders separated and easily accessed by the customer; this would be particularly useful in a multiple-shipment designated site such as that illustrated in FIG. 6A.

FIG. 6A shows a multiple-shipment room designated site 120. In such an embodiment, there is a relative large room 670, in which the shipment packages 600, 610, 620, 630, 640 and 650 corresponding to multiple different orders placed by different individuals are stored. In certain embodiments, controlled-environment sub-compartments 642 can be provided within the larger DS room 670, for instance to refrigerate the contents of certain specific shipments (e.g., 640). Other such sub-compartments could control humidity or light, for instance, or a combination of any of these characteristics.

The DS interface 510 of this type of DS is generalized, in that it controls the entrance of each individual to the interior space 670 of the multiple-shipment room DS. Likewise, each individual enters the interior space 670 through the same retrieval entrance 520a. In some embodiments, employees of the system also use this entrance to deliver shipments. In other embodiments, delivery of shipments occurs through a dedicated delivery door 660a.

FIG. 6B shows an individual-shipment, bi-access-designated site. In DSs with such a format, there are several different sub-rooms 672, each of which has two access doors 520 and 662. The exterior access door 520b is the retrieval door through which the individual retrieves their package(s) after they have been verified through interaction with the DS interface 510. The interior door 662 of each sub-room 672 serves as the interior delivery door, permitting an employ of the system, who has entered the DS through the exterior delivery door 660b to deliver individual shipments to each sub-room. This type of DS offers the added benefit of permitting storage facilities within the DS but separate from the member-accessible interior space, without the need for additional secure doors.

Each shipment (e.g., 600, 610, 620 and 630) is placed in an individual sub-room 672 to await retrieval. Each sub-room 672 may be equipped with a sub-room specific DS interface 510 as depicted. Alternatively, a single DS interface can be provided that allows and monitors access to individual sub-rooms based on the identity of the person picking up the package (in other words, depending on which shipment is being retrieved).

Individual sub-rooms of this format can be environmentally controlled, for instance with controlled temperature, humidity or light, for the storage of special-need shipments (e.g., for refrigerated items).

As or before a shipment arrives at the DS, it is assigned a sub-room. This sub-room may or may not be one that has previously been used by the member/individual who placed the order for the shipment. There is generally no assignment of sub-rooms to particular individuals within the system. Since the sub-rooms are not generally associated with a single member/individual, there is no absolute requirement that a DS have a sufficient number of sub-rooms to accommodate all of the members who generally use that DS.

FIG. 6C shows an individual-shipment, single-access-designated site. This site format is similar to the bi-access-designated site of FIG. 6B, except that delivery and retrieval of shipment packages occurs via the same exterior access door 520c. This system format has the advantage of providing maximal shipment storage space with minimal footprint of the DS facility 120.

As for the bi-access system, each shipment (e.g., 600, 610, 620 and 630) is placed in an individual sub-room 674 to await retrieval. Each sub-room 674 may be equipped with a sub-room specific DS interface 510 as depicted. Alternatively, a single DS interface can be provided as described.

Individual sub-rooms of this format can be environmentally controlled, for instance with controlled temperature, humidity or light, for the storage of special-need shipments (e.g., for refrigerated items).

Similarly to the bi-access system, shipments are assigned a sub-room before or during delivery. This sub-room may or may not be one that has previously been used by the member/individual who placed the order for the shipment. There is generally no assignment of sub-rooms to particular individuals within the system. Since the sub-rooms are not generally associated with a single member/individual, there is no absolute requirement that a DS have a sufficient number of sub-rooms to accommodate all of the members who generally use that DS.

B. Individual Vehicle Direct Delivery

Another manner of delivery would involve automated delivery into the customer's personal vehicle, as depicted in FIG. 6D. This version of the system would involve, for instance, an employee at a large employer 750. The customer would order goods, the goods would be send to a CDC, as described above, and the shipped to the DS. However, in this case, the DS 120 would involve a manual or robotic delivery vehicle 710 going to each customer's individual car (e.g., 720, 722, 724, 726, 728, 730, 732, and 734). When the customer's package is scheduled for delivery, the customer would be notified automatically (computer-generated wireless call, pager, e-mail, telephone call, etc.) instructing the customer to park his vehicle in a pre-determined parking space (e.g., as generically indicated by 760) at the DS parking lot. A delivery vehicle 710 would then approach the customer's vehicle (e.g., 720), which would have an identifying coded tag on, for instance, the rear bumper. The, for instance, robotic delivery vehicle/robot 710 would identify the vehicle by the coded tag, confirm that the car belongs to the correct customer, and confirm that customer still wants the package scheduled for delivery (information that could be encoded in the smart chip of the label of the shipment, for instance). Upon completion of this digital verification, the customer's car trunk 721 would automatically be opened. The robot 710 would then perform an examination of the trunk 721 interior to ensure there is sufficient room to insert the shipment; insufficient room would cause the shipment to be delayed and/or a message sent to the individual notifying them of the difficulty. If there were sufficient room in the trunk 721, the robot 710 would place the goods in the trunk, and close the lid. Closing the lid could serve as a signal to the system to confirm delivery to the customer, the seller, the DC, etc. The robot would continue down the line of customer cars (e.g., next to car 722) until all deliveries were completed.

Optionally, such a DS could also include a system-related storage facility 700 for the storage of shipments prior to their delivery to a member's vehicle, or potentially longer storage in case of a missed delivery. This storage facility 700 could also optionally include non-vehicle dependent DS capability as is described elsewhere herein.

### IV. Security and Monitoring

A further benefit of the distribution systems and methods of the invention are that they offer greater security and assurance than prior distribution methods. Security aspects of the system include the smart-chip labeling of each shipment, limited access to the DS to pick-up shipments, and monitoring devices at the DS that are capable of recording or otherwise noting who has accessed the site and what, if anything, they removed.

A. Package-linked Security and Monitoring

The smart label that is attached to each shipment prior to its leaving a CDC, is instrumental in the security and monitoring of packages moving in the disclosed distribution systems. Details of how these labels can be used for security and monitoring have been discussed above.

It is also possible to lock the shipment such that only the intended end recipient (e.g., the member/individual who placed the order or a designated agent) can open the package(s) of the shipment. In certain embodiments, for instance, the package can only be unlocked with provision of the appropriate ID card or ID key of the member/individual.

The product delivery package (shipment) could be encoded with product weight information. This would be useful for determining shipping costs, and verifying that the goods intended to be included were actually included and that nothing was either added to or taken from the package at any point along with way once consolidation had occurred, etc. In certain embodiments, the weight is measured at various points throughout the distribution process, for instance upon entry to and/or departure from each individual component of the distribution system (e.g., the CDC). As the weight of each container and the packaged products contained therein is known, the gross weight of the sealed loaded container(s) can be verified as the shipment moves through distribution to points “down line” from packaging. This weight verification can be carried out on a continuous basis throughout the shipment process. Instantaneous weights at various points during transport can be matched with the customer's order so as to weight-verify the packed order (shipment). This would provide a record that all of the appropriate items of the shipment were in the shipment container at each stage of distribution.

In some embodiments, product weight information could be constantly updated through the inclusion of a weighing means in the shipment packing materials, for instance a small scales or other weighing mechanism in the bottom surface of the shipment packaging box such that the contents of the shipment are constantly being weighed. If such a weighing mechanism were linked into the distribution system computer, tracking of all items within the shipment would be automatic, reducing the involvement of people in the monitoring process.

B. DS-related Security and Monitoring

An important aspect of the DSs of the invention is that they are secure from misappropriation of the shipments contained therein. Any conventional methods for monitoring DS access are appropriate for use with the distribution system described herein. For instance, in certain embodiments, on-board video cameras monitor all activity inside the trailer, including returns.

In addition, the shipment package(s) can only be removed from the DS with appropriate identification from the person retrieving the packages. This security measure is accomplished in many embodiments by limiting access to the DS to only member/individuals who have shipments awaiting retrieval. In addition, the member/individual or designated agent must access the DS through use of his or her ID card or other ID means (e.g., a key or direct biometric information such as a fingerprint or retinal scan). This ID (whether it be a card, or a ring or some other physical device) can also serve to permit removal of the shipment from the DS without setting off an alarm.

In certain embodiments, especially those that employ a multiple-shipment room designated site (e.g., FIG. 6A), it is possible to make shipments removable only by their intended recipient. Once a member/individual has been granted access to the interior of the DS, he or she must be limited to retrieval only of their own shipment packages. This can be ensured through various methods, including the storage of shipment packages in cages or other partitions that only unlock for the designated recipient.

Alternatively, the shipment package(s) can be locked in the DS in some manner; the locking mechanism is disengaged when the correct recipient arrives and gains entry to the DS. For instance, the package could be physically locked to a retaining mechanism in the DS, which releases when the door lock is released to admit the recipient. In another embodiment, where metallic magnetizable packaging materials are appropriate, the package(s) can be magnetically locked to the inside of the DS through a controllable magnetic field. This field may be locally modulated to release the appropriate package(s) of the shipment for retrieval.

### V. Optional Aspects of the Distribution Systems and Methods

Various optional aspects or sub-systems can supplement the distribution system and methods described above. These sub-systems include methods for further increasing the efficiency or decreasing the polluting aspects of the distribution system, and include a sub-system for package/shipment return that employs essentially the same elements as those used for package distribution, member/individual driven customizing of the information linked to each order (the order data packet), and automatic replenishment of consumables. These sub-systems will now be described in further detail.

A. Package/Shipment Return

Returns would be handled by the customer calling into the system to notify it of an intended return. The system would then authorize the return at the DS. The customer would go to the DS with the return goods, put their ID card in a slot, and receive an approved return wrapper/container and locking return product tag, which would lock onto and seal the wrapper/container with the goods inside. The customer would be responsible for placing the tag on the item(s), going back into the trailer, and putting it in the return shelf.

The process of returns would also be made more efficient by this system. For example, a customer would have the ability to call in to notify the system that the customer would not be available to pick up goods out of a trailer or would not have their car in the designated parking spot at a given time, and in essence reschedule the delivery. Certain additional charges could be assessed for rescheduling.

B. Sample Inclusion at the CDC

It is a further optional aspect of the current invention that, when the order is consolidated at the CDC for instance, the system can include additional items such as advertising or promotional samples in the shipment. The choice of what sample(s), if any, to include and which shipments in which to include such samples can be based on any criteria. For instance, accumulated data on the purchasing habits of the member/individual could be used to ensure that appropriate (e.g., potentially desired) samples are directed to the appropriate member. Alternatively, in some instances, the choice of inclusion could be based on a statistical probability chart, or a random table, or even in some instances the sample would be included in all shipments during a certain period of time.

C. Individual Tailoring of the Order Data Packet

When a Customer places an order via telephone, online, or otherwise, a Digital Order Packet (DOP) is generated and cannot be changed except as predetermined by or allowed by the customer or agreed upon protocol between Customer and Delivery Network. For example, if a product X is not available by Y time send order basket without product X; substitution of an out of stock product may be predetermined or system may be (pre)programmed to digitally contact customer with several choices based on a customer profile and wait for a set time (which may vary depending on the level of priority placed on the remaining goods) for response before allowing products to begin moving toward pack out area or from suppliers to the CDC.

The information that is used to tailor the DOP can be modified and specified by the individual customer. For instance, in some systems the customer individual may input information detailing their preference(s) on product substitution in case of unavailability, preferred delivery time(s), etc.

DOPs may split the order to conform to customer preferences depending on the location of the goods in the Ordered Basket (OB), so that different product groups within the OB may arrive at different times and from different locations or CDCs. A key benefit is that customers are empowered to customize the delivery of their OB in content, timing, and cost to maximize their satisfaction. Other customizable choices might include: Order delivered by X time if not canceled; can be sequenced or summed so that if item A cannot be delivered until time Y, then wait to delivery items B-F-H at time Y when A is delivered; spacing of delivery so that item A is delivered a certain number of (for instance, three) days before item C.

In certain embodiments, the DOP may search delivery scenarios and communicate to the individual customer that waiting a certain amount of time (for instance, one week) may reduce costs by some amount. The individual customer could then be given the opportunity to choose delivery time based at least in part on the expected cost.

D. Automatic Replenishment Sub-system.

The distribution system disclosed herein can be supplemented by a sub-system that monitors the need for replenishment of one or more items that may be transported within the system. In such a sub-system, the product for which monitoring is desired is associated with a mechanism that automatically monitors one or more characteristics that may be indicative of a need for product replenishment. Various indicators, including weight and/or tagging (or other measurement sensors integral to the tag and part of packaging or external to it) of product may be used to determine when there is a need to replenish the product.

Depending on the particular embodiment being considered, tags may measure any characteristic that is indicative of a need for replenishment (and thereby a need for a replenishing delivery) by sensing pressure, temperature, light, weight, moisture, movement, elevation and/or variations within or between these variables.

The basic elements of the invention can be seen in the following examples:

### EXAMPLES

### Example 1

### Distribution System

An individual applies for a membership in the “system.” He receives a personal ID (referred to as the “ID”, which could be in the form of biometric information, like a retinal scan, digital thumbprint, etc.). For purposes of this example, the use of an encoded card will be assumed, although other methods of identification may be used. The member calls and places an order for a “basket of goods.” The system transmits appropriate portions of the member individual's order to the appropriate manufacturer(s), who then tag the goods (correlate the specified item or items to the member's ID) and ship them from various locations (e.g., the factory or the factory's fulfillment DC) to a consolidating distribution center (“CDC”), for instance the CDC closest to the member.

At the CDC, the individual goods are packaged together to form a shipment, and the shipment is labeled. The customer's ID, ordering information, cost of products, method of payment, and other information may be transferred electronically to a smart chip located on the container(s) of the shipment. Alternatively, only information like package or item weight, generic product type, DS location, time and/or day of delivery need be programmed into the chip. After labeling is complete, the shipment loaded onto a trailer or other appropriate shipping conveyance (e.g., a train or boat) for delivery to a secure substantially unattended designated item exchange site (“DS”).

When the customer's order is at or nearing the DS, the customer is notified, for instance via wireless communication, pager, e-mail, automated telephone call, etc., of the imminent arrival. The customer then travels to the DS (for the sake of this example, a “multiple shipment room DS” as disclosed in FIG. 6A). In order to enter the DS 670, the customer (or another person pre-authorized by the customer, such as a spouse or child of the customer—a designated agent) places an appropriate ID card in the slot in the interface 510 and is confirmed and allowed access via a door 520. This verification process simultaneously activates lights, a beeping sound, or the like to enable the customer to find his shipment package(s) 600 inside the multiple shipment room DS 670. In alternative embodiments, the shelf on which the shipment 600 is stored may light up, or the location of the shipment 600 can otherwise be indicated within the DS 670. For instance, the member/individual ID key device may contain a homing device that reacts directly to the presence of the shipment and provides an indication of its location within the DS. Such indication could be of the hot-cold variety, where the device changes a behavior in a recognizable way as it nears the shipment (e.g., a light on the ID device flashes faster the closer the it is to the correct shipment, or a light gets brighter, or a buzzer changes tone or speed of beeping, or the like).

Perishable goods could, for instance, be stored in individual refrigeration units 642—essentially small, automated ice chests.

When the member/individual finds the package, the member/individual slips the ID card (or other identifying key) into or across (which may not require physical contact) the shipment smart label, which causes the label to detach and allows the package to be taken from the trailer via door 520 without setting off an alarm. This may also unlock the shipment, for instance if the shipment is in a secure container. In certain embodiments, the smart label is merely inactivated upon retrieval of the shipment, rather than removed.

In those embodiments where the smart label is removed at the DS, it can be placed in a special slot, which could serve to confirm package retrieval and simultaneously recycle the tags without leaving the DS 670. Placing the tag in the slot or bin can automatically send an electronic delivery confirmation to the seller, the DC, the customer, etc. All packaging materials can easily be left in the trailer for re-use and/or recycling. Alternatively, if the member/individual chooses to take the packaging materials (with or without the label) away from the DS, these materials can be returned later for credit. When packaging material is removed from the DS, however, the member/individual would automatically be charged for the costs of such items (i.e., as a sale of the packaging to the member/individual); return of these materials would result in a corresponding credit. This system will encourage more recycling and the use of more durable packaging materials.

### Example 2

### Neighborhood DSs

An alternative to the DSs described above could be a centralized, neighborhood drop-off site. A single delivery truck could service several neighborhood drop-off sites. The truck would be loaded with a “neighborhood pod or container” packed with multiple packages for individuals customers living near the drop-off site. Drop-off sites would have powered coupling mechanisms that allow them to be in essentially constant contact with the system. These mechanisms could be powered by either solar energy, a battery, or direct wired to a municipal or local grid, or a combination of these. Similar to the DS example described above, a customer could receive notice of their delivery through a wireless communication link to the shipment or delivery vehicle.

By using GPS and wireless communications technology, a customer could specify in advance that he be notified, for instance, one hour before his package is scheduled to be delivered, in essence a digital, automated system for estimating time of arrival (“ETA”) of packages. This same ETA system could be used for any type of package or letter. The delivery vehicle(s) in the chain of transport each would have a GPS device installed. The smart chip or other identification technology on each package would allow the system to associate individual packages with a GPS-locatable vehicle (or site, if the package were at a DC) at any given moment. When the vehicle reaches the distance/time prescribed by the customer for advance ETA notice, the system would automatically do so. For greatest accuracy, the delivery system would be aware of a pre-assigned route and schedule for the delivery vehicle, so that travel delays could be taken into consideration when determining the ETA. The system would again notify the customer when the package reaches its final destination.

The individual customers from the neighborhood would be able to pick up their individual packages at the neighborhood site in a similar manner to those described above (e.g., slide ID card through slot to authorize pick up, etc.). Among other advantages over present methods, this method of making grouped deliveries to neighborhood sites enhances efficiencies, maximizes use of delivery vehicles, reduces overall traffic congestion by reducing the number of vehicles (both delivery trucks and customer cars) on the roads, reduces fuel consumption and, thereby, pollution, and enables customers to use their time more efficiently, both in ordering and pick up of goods.

### Example 3

### Optional Automatic Replenishment Sub-system

This sub-system permits a member-individual to link consumable goods into the distribution system, so that replenishing orders are handled on an automatic or semi-automatic basis.

The optional automatic replenishment sub-system can be used, for instance, to monitor the amount of a food commodity in a personal household. For instance, in the case of milk, a milk carton has a replenishment-monitor tag and is removed from a weight-sensitive shelf, partially emptied and placed back on shelf. The shelf/tag system determines and notes the change in the weight of the milk carton and transmits this information to a computer. The computer determines when to deliver more milk, based on information that may include, for instance, customer use patterns (e.g., number and habits of milk users currently occupying house) and the amount of milk remaining in the carton. The computer then sends an appropriate signal to the system computer that places an order for more milk to be delivered via the distribution system.

This sub-system is also useful in instances where groups of individuals or members order the same or similar items (for instance, ten people order a gallon of milk each). Bulk packages of such items (for instance, a case of twelve gallon bottles of milk) can be jointly delivered to a neighborhood DS and placed in an appropriate (i.e., refrigerated) area from which each individual member can retrieve his or her single gallon delivery. This system can be thought of as an individual “pick and pack” system within the DS, and may be particularly useful in instances of items that are ordered often and/or by a large number of individuals within an area.

The foregoing examples are provided by way of illustration only. One of skill in the art will appreciate that numerous variations on the implementation details of the distribution systems and methods described above are possible.

1. A method of distributing items, the method comprising:
receiving an order from a first individual for at least one item;
procuring the at least one item ordered by the first individual thereby producing a first shipment;
receiving an order from a second individual for at least one item;
procuring the at least one item ordered by the second individual thereby producing a second shipment;
placing the first and second shipments into a container; and
transporting the container containing the first and second shipments to a substantially unattended secure designated item exchange site (DS) where the first individual or a first designated agent can retrieve the first shipment from the container and where the second individual or a second designated agent can retrieve the first shipment from the container.

2. The method of claim 1 wherein control of access to shipments in the container at the DS is at least semi-automated.

3. The method of claim 2 wherein control of access to shipments in the container at the DS is fully automated.

4. The method of claim 1 further comprising accessing a shipment in the container at the DS by the individual though use of a personal identifier in order to retrieve the shipment.

5. The method of claim 4 wherein the personal identifier identifies the individual at least in part through information chosen from the group consisting of biometric, numeric, alpha-numeric, alphabetic, physical, statistically assigned and randomly assigned.

6. The method of claim 5 wherein the biometric information is chosen from the group consisting of a retinal scan, a digital thumb print, a voice print, a chemical skin print, a pheromone print, a genetic print, an odor print and combinations thereof.

7. The method of claim 5 wherein the personal identifier is encoded in a physical key.

8. The method of claim 7 wherein the physical key is chosen from the group consisting of a key card and a biological sample.

9. The method of claim 8 wherein the biological sample is chosen from the group consisting of sweat, blood, spittle, breath, hair, dermal cells, dermal cell contact and mixtures thereof.

10. The method of claim 4 further comprising triggering a notification system upon accessing the container or retrieval of the shipment.

11. The method of claim 10 wherein the notification system notifies at least one party chosen from the group consisting of an item supplier, a distribution center, a consolidated distribution center, and an individual.

12. The method of claim 1 further comprising labeling each shipment with information relating to an individual, an individual personal identifier, the order, the at least one item, and the secure designated site.

13. The method of claim 1 further comprising labeling each shipment by providing a smart chip.

14. The method of claim 1 wherein at least one item originates from a first supplier and at least one item originates from a second supplier.

15. The method of claim 1 wherein the receipt of orders is restricted to orders received from individuals who are members of a members-only distribution system.

16. The method of claim 1 wherein the container is a trailer.

17. A members-only distribution system comprising:
a computer capable of monitoring the distribution system including shipments of items ordered by members;
at least one consolidating distribution center (CDC);
at least one substantially unattended secure designated item exchange site (DS);
a plurality of containers, each capable of transporting plural shipments between the at least one consolidating distribution center and the at least one substantially unattended secure designated item exchange site, the secure designated item exchange site and the containers being configured for limited access such that a shipment of an item ordered by a member can be retrieved from a container at a secure designated item exchange site only by the member or by an agent designated by the member.
